(19) United States
(12) Patent Application Publication
(10) Pub. No.: US 2025/0368172 A1
(43) Pub. Date: Dec. 4, 2025

(54) VEHICLE BRAKE APPARATUS

(71) Applicant: TOYOTA JIDOSHA KABUSHIKI KAISHA, Aichi-ken (JP)

(72) Inventor: Taisuke YAMADA, Toyota-shi (JP)

(21) Appl. No.: 19/209,796

(22) Filed: May 16, 2025

(30) Foreign Application Priority Data
May 31, 2024 (JP) 2024-088697

(51) Int. Cl. B60T 8/58; A63F 13/65; A63F 13/803; B60T 8/171; B60T 8/172; B60T 8/40

(52) U.S. Cl. CPC B60T 8/58; A63F 13/803; B60T 8/171; B60T 8/172; A63F 13/65; B60T 8/4081; B60T 2210/20; B60T 2220/04; B60T 2250/04; B60T 2270/82

(57) ABSTRACT

A vehicle brake apparatus includes an operation member, an electric actuator configured to control a traveling state of a vehicle in which a coupling between the electric actuator and the operation member is mechanically disengaged, and a controller configured to control an operation of the electric actuator in accordance with an operation to the operation member. The vehicle brake apparatus includes a brake operation member included in the operation member, and a brake actuator included in the electric actuator. The controller is configured to obtain mode-selection information and, in response to selecting a particular mode based on the obtained mode-selection information, in which the control of the traveling state is not performed, limit at least the operation of the brake actuator in accordance with the operation of the brake operation member.

### REFERENCE TO RELATED APPLICATIONS

This application claims priority from Japanese Patent Application No. 2024-088697 filed on May 31, 2024. The entire content of the priority application is incorporated herein by reference.

### TECHNICAL FIELD

The present disclosure relates to a vehicle brake apparatus.

### BACKGROUND ART

Conventionally, for example, a driving operation apparatus and a virtual driving system disclosed in Japanese Patent Application Publication No. JP-A-2014-119657 (hereinafter, simply referred to as a “conventional apparatus”) have been proposed. When a virtual operation is selected from an actual operation and the virtual operation by an operation button provided in a vicinity of a driver's seat or the like, the conventional apparatus restricts start of the engine. And, the conventional apparatus is configured to output an operation signal related to an operation of a steering wheel in the virtual driving and an operation signal related to an operation of a brake in the virtual driving to an external device.

### SUMMARY

By the way, in the conventional apparatus, the start of the engine is restricted and a steering of a steering unit of a steer-by-wire type is restricted in the virtual driving, however the restriction of the operation of the brake is not considered. As a result of this, when the brake is operated in the virtual driving, the conventional apparatus operates such that the brake generates braking force even though the vehicle is in an un-running state (an un-traveling state). In this case, there is a possibility that an unnecessary load is applied to a member that operates to generate braking force or energy is wastefully consumed along with the operation.

An object of the present disclosure is to provide a vehicle brake apparatus capable of suppressing an operation frequency in a state in which a traveling state of a vehicle is not controlled.

In one aspect of the present disclosure, a vehicle brake apparatus is applicable to a vehicle. The vehicle includes an operation member, an electric actuator configured to control a traveling state of the vehicle in which a coupling between the electric actuator and the operation member is mechanically disengaged, and a controller configured to control an operation of the electric actuator in accordance with an operation to the operation member. The vehicle brake apparatus includes a brake operation member included in the operation member, and a brake actuator included in the electric actuator. The controller is configured to control an operation of the brake actuator such that braking force is applied to at least one wheel of the vehicle in accordance with an operation to the brake operation member. The controller is configured to obtain mode-selection information indicating whether or not a control of the traveling state is to be performed by the operation of the electric actuator in accordance with the operation to the operation member, and, in response to selecting a particular mode, based on the obtained mode-selection information, in which the control of the traveling state is not performed, limit at least the operation of the brake actuator in accordance with the operation of the brake operation member.

According to the present disclosure, when the particular mode in which the traveling state is not controlled is selected, the vehicle brake apparatus can limit at least the operation of the brake actuator corresponding to the brake operation member. Accordingly, in the vehicle brake apparatus, an operation frequency of the brake actuator can be suppressed. As a result, it is possible to suppress an unnecessary load from being applied to a member that operates so as to generate braking force, and it is possible to suppress wasteful energy consumption along with the operation.

### BRIEF DESCRIPTION OF DRAWINGS

The objects, features, advantages, and technical and industrial significance of the present disclosure will be better understood by reading the following detailed description of an embodiment, when considered in connection with the accompanying drawings, in which:

FIG. 1 is a schematic configuration diagram of a vehicle;

FIG. 2 is a diagram indicating a configuration of a hydraulic brake device of a vehicle brake apparatus and for explaining an operation state in a particular mode;

FIG. 3 (A) is a view for explaining a brake of the hydraulic brake device;

FIG. 3 (B) is a view for explaining an electric parking brake device;

FIG. 3 (C) is a view for explaining an electric brake device, which constitute the vehicle brake device;

FIG. 4 is a flowchart of a particular mode transition program;

FIG. 5 is a view for explaining the vehicle brake apparatus according to a modification; and

FIG. 6 is a view for explaining the vehicle brake apparatus according to a modification.

### DESCRIPTION

Hereinafter, there will be described a vehicle brake apparatus 10 according to an embodiment of the present disclosure in detail with reference to drawings. It is noted that, in addition to the embodiments described below, the present disclosure can be implemented in various forms with various modifications and improvements based on the knowledge of those skilled in the art.

Configuration of Vehicle to which Vehicle Brake Apparatus is Applied

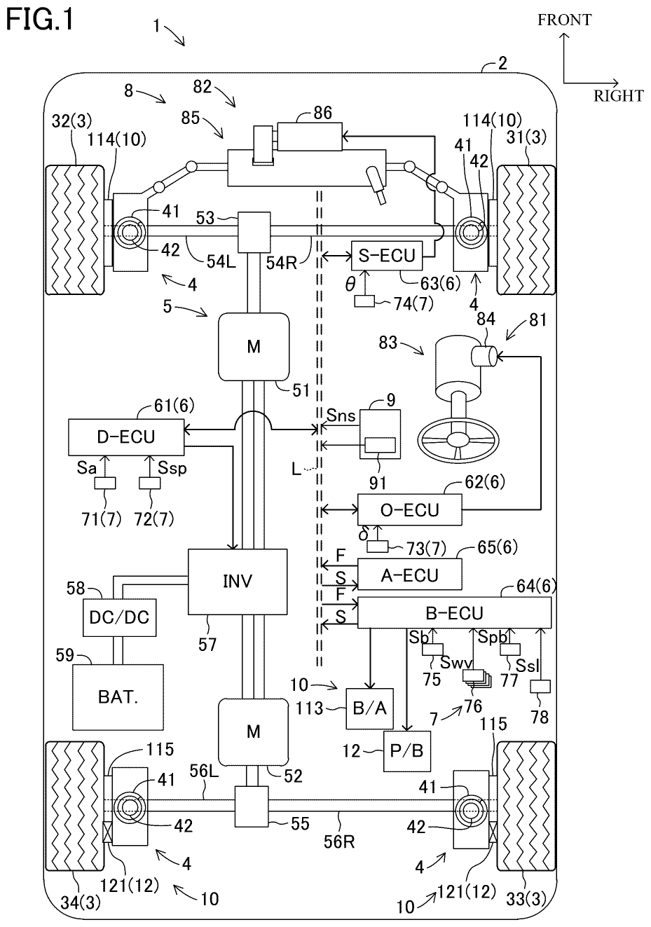

In the present embodiment, the vehicle brake apparatus 10 is applied to a vehicle 1 illustrated in FIG. 1. The vehicle 1 comprises a vehicle body 2, wheels 3 disposed on a front right side, a rear right side, a front left side and a rear right side, a suspension unit 4 supporting the vehicle body 2 and each of the wheels 3. The wheels 3 includes a front right wheel 31, a front left wheel 32, a rear right wheel 33 and a rear left wheel 34. The suspension unit 4 includes, for example, a coil spring 41 and a shock absorber 42.

Moreover, the vehicle 1 includes a drive system 5 that generates and transmits driving force necessary for traveling. In the present embodiment, the drive system 5 includes a front motor 51 and a rear motor 52 included in the electric actuator. The front motor 51 drives the front right wheel 31 and the front left wheel 32 by transmitting rotation of an output shaft to left and right front wheel axles 54L and 54R via a differential gear 53 (including a reduction gear). The rear motor 52 drives the rear right wheel 33 and the rear left wheel 34 by transmitting rotation of an output shaft to left and right rear wheel axles 56L and 56R via a differential gear 55 (including a reduction gear). That is, in the present embodiment, an electric vehicle (EV) of a four-wheel drive type is exemplified as the vehicle 1.

Moreover, the drive system 5 includes an inverter 57, a DC/DC converter 58, and a battery 59. As a result of this, the front motor 51 and the rear motor 52 can be independently driven in a forward rotation in a forward direction of the vehicle 1 and a reverse rotation in a backward direction of the vehicle 1 by an energization control of the inverter 57.

Moreover, the inverter 57 has a charging port (not shown). For example, the inverter 57 has a charging function of converting an alternating current supplied from a charging facility into a direct current and charging the battery 59 via the DC/DC converter 58. Further, the inverter 57 also has a function of, for example, converting an alternating current generated by the rear motor 52 in regenerative braking into a direct current and charging the battery 59 via the DC/DC converter 58, that is, a function of storing regenerative energy.

An operation of each of the front motor 51 and the rear motor 52 is controlled by a drive electronic control unit 61 (hereinafter, simply referred to as the “drive ECU 61”) included in a controller 6. The drive ECU 61 is an electronic control unit including, as a main part, a microcomputer having a CPU, a ROM, a RAM, and various kinds of interfaces. In FIG. 1 and the like, the drive ECU 61 is indicated by the “D-ECU 61”.

The drive ECU 61 inputs a detection signal Sa of an accelerator sensor 71 that detects an accelerator operation amount of an accelerator as an operation member in a sensor group 7, and calculates a driver request driving force in accordance with the accelerator operation amount. Further, the drive ECU 61 obtains an operation position of a shift lever, a shift switch, or the like (not shown) that is operated when the vehicle 1 is moved forward or backward or parked. Therefore, the drive ECU 61 inputs a detection signal Ssp indicating the operation position output from the shift position sensor 72 of the sensor group 7.

Moreover, the vehicle 1 also includes a steering system 8 that steers or turns the right front wheel 31 and the front left wheel 32 as steered wheels during traveling. The steering system 8 is of a steer-by-wire type including an operation device 81 and a steering device 82 that are mechanically independent of each other.

The operation device 81 includes a steering wheel, a steering shaft, and a steering column, which are operation members. Moreover, the operation device 81 includes a reaction force applying actuator 83 included in the electric actuator. The reaction force applying actuator 83 includes a reaction force motor 84 as a driving force source.

The reaction force motor 84 of the operation device 81 is controlled by an operation electronic control unit 62 (hereinafter, may be simply referred to as the “operation ECU 62”) included in the controller 6. The operation ECU 62 is an electronic control unit including, as a main part, a microcomputer having a CPU, a ROM, a RAM, and various kinds of interfaces. The operation ECU 62 is connected to a communication line L via various kinds of interfaces. It is noted that, in FIG. 1, the operation ECU 62 is indicated by the “O-ECU 62”. The operation ECU 62 is connected to an operation angle sensor 73, of the sensor group 7, that detects an operation angle S indicating an operation position of the steering wheel.

The steering device 82 turns, as one body, the front right wheel 31 and the front left wheel 32, which are turnably supported by the vehicle body 2. The steering device 82 includes a steering actuator 85 included in the electric actuator. The steering actuator 85 includes a tie rod, a steering rod, a housing, and a rod moving mechanism. The steering actuator 85 includes a steering motor 86 as a driving force source for moving the rod moving mechanism.

The steering motor 86 of the steering device 82 is controlled by a steering electronic control unit 63 (hereinafter, simply referred to as the “steering ECU 63”) included in the controller 6. The steering ECU 63 is an electronic control unit including, as a main part, a microcomputer having a CPU, a ROM, a RAM, and various kinds of interfaces. The steering ECU 63 is connected to the communication line L via various kinds of interfaces. It is noted that, in FIG. 1, the steering ECU 63 is indicated by the “S-ECU 63”. The steering ECU 63 includes a steering angle sensor 74 that detects a steering angle θ indicating a steering position of the front right wheel 31 and the front left wheel 32 of the sensor group 7.

Moreover, the vehicle 1 of the present embodiment includes a navigation device 9. The navigation device 9 is connected to the communication line L, and can output a signal Sns representing a slope gradient which is attribute information of a road on which the vehicle 1 is traveling. It is noted that, in the present embodiment, the signal Sns is output to the vehicle brake apparatus 10, which will be described below. Moreover, the navigation device 9 includes, for example, a touch panel 91 using a display for displaying a map. As a result of this, occupants of the vehicle 1 can use the touch panel 91 to request transition between a normal mode in which a control of a traveling state of the vehicle 1 is performed and a particular mode in which the control of the traveling state of the vehicle 1 is not performed.

### Configuration of Vehicle Brake Apparatus

Further, as shown in FIGS. 1, 2, and 3, the vehicle 1 includes (a) a vehicle brake apparatus 10 that generates braking force necessary for braking. The vehicle brake apparatus 10 includes a hydraulic brake device 11 that applies the braking force to each of the wheels 3 apart from the regenerative braking by the rear motor 52 described above, and (b) an electric parking brake device 12 that applies braking force to, for example, in the present embodiment, each of the rear right wheel 33 and the rear left wheel 34 when the vehicle 1 is stopped.

The hydraulic brake device 11 includes a master cylinder 112 coupled to a brake pedal 111 that is a brake operation member. Further, the hydraulic brake device 11 includes a brake actuator 113 that is included in the electric actuator and regulates and supplies hydraulic oil pressurized by a pump. It is noted that, in FIG. 1 and the like, the brake actuator 113 is indicated by the “B/A113”. Further, the hydraulic brake device 11 includes a front-wheel-side brake 114 for decelerating rotation of each of the front right wheel 31 and the front left wheel 32, and a rear-wheel-side brake 115 for decelerating rotation of each of the rear right wheel 33 and the rear left wheel 34.

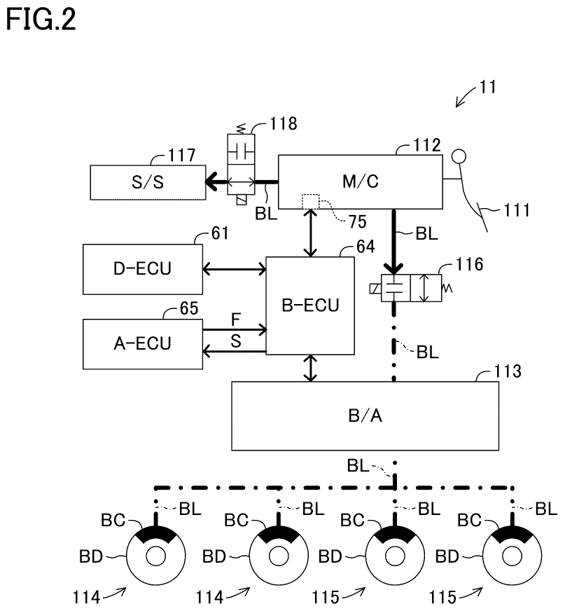

As shown in FIG. 2, the master cylinder 112 supplies hydraulic oil at a pressure corresponding to brake operation force applied to the brake pedal 111. As a result of this, in a state in which a master cut valve 116, which is a normally open electromagnetic on-off valve, is in an open state, the master cylinder 112 can supply the hydraulic oil having the pressure corresponding to the brake operation force to each of the front-wheel-side brakes 114 and the rear-wheel-side brakes 115 via the brake actuator 113. On the other hand, in a state in which the master cut valve 116 is in a closed state, the master cylinder 112 cannot supply the hydraulic oil to each of the front-wheel-side brakes 114 and the rear-wheel-side brakes 115.

Moreover, the brake pedal 111 is connected, via the master cylinder 112 and a simulator cut valve 117, to a stroke simulator 118, which is an operation reaction force device. The simulator cut valve 117 is a normally closed electromagnetic on-off valve. In a state in which the master cut valve 116 is in the closed state and the simulator cut valve 117 is in the open state, the stroke simulator 118 secures a depression stroke of the brake pedal 111 and applies operation reaction force corresponding to the depression stroke to the brake pedal 111. Thus, the stroke simulator 118 can improve feeling of the brake operation.

An illustration of a configuration of the brake actuator 113 is dispensed with, because a conventional configuration of a brake actuator can be applied to the brake actuator 113. The brake actuator 113 is provided with a master oil passage through which the hydraulic oil supplied from the master cylinder 112 is supplied to each of the front-wheel-side brakes 114 and the rear-wheel-side brakes 115 in the state in which the master cut valve 116 is in the open state. As a result of this, for example, in a case of an electrical failure, the brake actuator 113 brings the master cut valve 116 into the open state, thereby causing the master cylinder 112 to communicate with the front-wheel-side brakes 114 and the rear-wheel-side brakes 115.

Moreover, the brake actuator 113, although not shown, includes a pump or an electric cylinder each driven by an electric motor, a control holding valve that regulates pressure of the hydraulic oil pressurized by the pump or the electric cylinder and supplies the hydraulic oil to the front-wheel-side brakes 114 and the rear-wheel-side brakes 115, a shut-off valve that is a normally-closed electromagnetic on-off valve, and the like. As a result of this, in a case where the normal mode is selected, the master cut valve 116 is switched to the closed state, whereby the brake actuator 113 can supply the pressure-regulated hydraulic oil to the front-wheel-side brakes 114 and the rear-wheel-side brakes 115 except in a case of the particular mode.

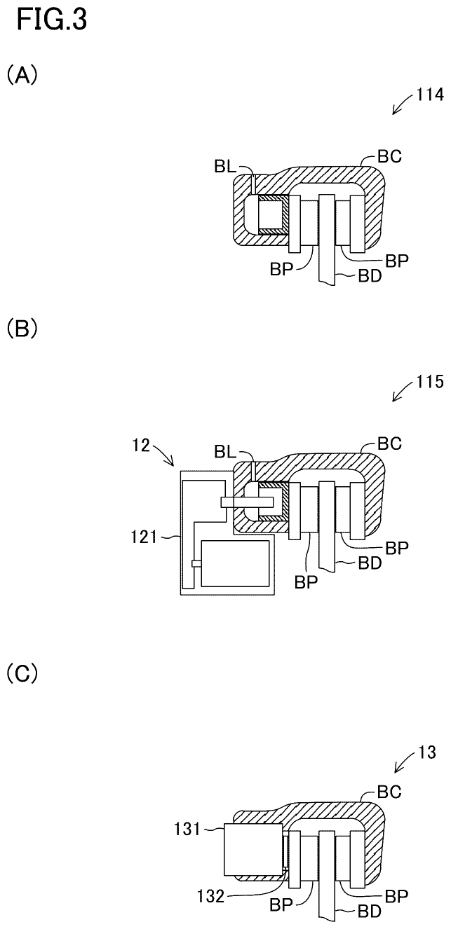

As shown in FIG. 2, FIG. 3A, and FIG. 3B, each of the front-wheel-side brakes 114 and the rear-wheel-side brakes 115 includes a brake disc BD that rotates integrally with the wheel 3, a pair of brake pads BP, and a brake caliper BC. The brake actuator 113 is connected to the brake caliper BC via a brake line BL. As a result of this, a hydraulic circuit of the hydraulic oil is formed between each of the front-wheel-side brakes 114 and the rear-wheel-side brakes 115, and the master cylinder 112 and the brake actuator 113. Therefore, in the hydraulic brake device 11, when the pressurized hydraulic oil is supplied from the master cylinder 112 or the brake actuator 113 to the front-wheel-side brakes 114 and the rear-wheel-side brakes 115, the brake pad BP presses the brake disc BD to generate braking force.

As shown in FIG. 3B, the electric parking brake device 12 includes an electric actuator 121 for mechanically braking the rear right wheel 33 and the rear left wheel 34. The electric actuator 121 is provided for the brake caliper BC. When a switching operation or the like is performed by the driver, the electric actuator 121 presses the brake pad BP accommodated in the brake caliper BC against the brake disc BD by the driving force of the electric motor. As a result of this, the electric parking brake device 12 generates braking force.

The control of the brake actuator 113 and the control of the electric actuator 121 are performed by a brake electronic control unit 64 (hereinafter, simply referred to as the “brake ECU 64” in some cases) included in the controller 6. The brake ECU 64 is an electronic control unit including, as a main part, a microcomputer having a CPU, a ROM, a RAM, and various kinds of interfaces. The brake ECU 64 is connected to the communication line L via various kinds of interfaces. It is noted that, in FIG. 1 and the like, the brake ECU 64 is indicated by the “B-ECU 64”.

The brake ECU 64 is connected to a brake sensor 75, four wheel speed sensors 76, a parking brake sensor 77, and a gyro sensor 78 of the sensor group 7. The brake sensor 75 detects a brake operation amount from a depression amount of the brake pedal 111. Each of the four wheel speed sensors 76 detects a speed of a corresponding one of the four wheels 3. The brake ECU 64 receives the detection signal Sb of the brake sensor 75 and calculates required braking force corresponding to the brake operation amount. And, the brake ECU 64 calculates friction braking force to be generated in each of the front-wheel-side brakes 114 and the rear-wheel-side brakes 115 and regenerative braking force to be generated in the rear motor 52 so as to realize the required braking force.

Here, the brake ECU 64 controls the operation of the brake actuator 113 based on a detection signal Swv of each of the wheel speed sensors 76 so as to generate the calculated friction braking force. As a result of this, the brake actuator 113 pressurizes the hydraulic oil and supplies the pressurized hydraulic oil to each of the front-wheel-side brakes 114 and the rear-wheel-side brakes 115, and each of the front-wheel-side brakes 114 and the rear-wheel-side brakes 115 applies a braking force to a corresponding one of the four wheels 3. Moreover, the brake ECU 64 transmits information indicating the calculated regenerative braking force to the drive ECU 61.

When the electric parking brake device 12 applies the braking force to the rear right wheel 33 and the rear left wheel 34, the brake ECU 64 receives a detection signal Spb output from the parking brake sensor 77. The detection signal Spb indicates a state in which the electric parking brake device 12 applies the braking force. Further, the brake ECU 64 receives, from the gyro sensor 78, a detection signal Ssl representing an inclination of the vehicle 1 in a front and rear direction, that is, a slope gradient which is the inclination of a road surface on which the vehicle 1 is stopped.

Moreover, the vehicle 1 also includes a particular mode electronic control unit 65 (hereinafter, simply referred to as the “particular mode ECU 65”) that realizes the particular mode in response to a request input via the touch panel 91, that is, a request for a state transition between the normal mode and the particular mode. The particular mode ECU 65 is an electronic control unit including, as a main part, a microcomputer having a CPU, a ROM, a RAM, and various kinds of interfaces. The particular mode ECU 65 is connected to the communication line L via various kinds of interfaces. In FIG. 1 and the like, the particular mode ECU 65 is indicated by the “A-ECU 65”

The particular mode ECU 65 performs the particular mode in which the drive system 5, the steering system 8, and the vehicle brake apparatus 10 are used as input devices only when the state transition from the normal mode to the particular mode is permitted based on a determination result by the brake ECU 64 as described below. Here, as the particular mode, a game mode, can be exemplified, in which a movement of a virtual moving object is controlled by using the input devices of the vehicle 1 in a state in which, for example, the vehicle 1 is charged. Moreover, as the particular mode, a remote operation mode, can be also exemplified, in which another vehicle located at a position away from the vehicle 1 is driven and caused to be traveled using the input devices of the vehicle 1, for example, due to an occurrence of a disaster or the like.

It is noted that, in the game mode, the occupants including the driver can visually recognize a game screen, for example, by using a display such as VR glasses. Further, in the remote operation mode, the driver can perform remote driving while visually recognizing surrounding environment of said another vehicle captured by cameras or the like mounted outside or inside said another vehicle, an image of a road on which the vehicle is traveling, an image of instruments in the vehicle, and the like, for example, by using the display such as the VR glasses.

### 3. Description of Operation of Vehicle Brake Apparatus

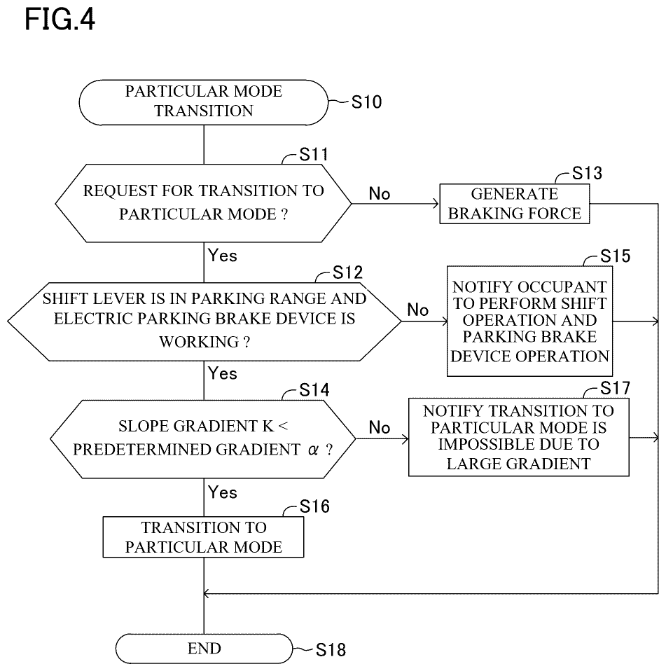

Next, there will be described an operation of the vehicle brake apparatus 10 of the present embodiment with reference to FIG. 4. The brake ECU 64 starts execution of a particular mode transition program shown in FIG. 4 in step S10, and determines whether or not a state transition from the normal mode to the particular mode is requested in subsequent step S11. Specifically, when the occupant of the vehicle 1 operates the touch panel 91 to request the state transition from the normal mode to the particular mode, the particular mode ECU 65 outputs a request flag F to the brake ECU 64 via the communication line L.

When the request flag F is input, the brake ECU 64 determines “Yes” in step S11 and executes a step process of step S12. On the other hand, when the request flag F is not input, the brake ECU 64 repeatedly determines “No” until the request flag F is input, and executes a step process of step S13, which will be described below.

In step S12, the brake ECU 64 determines whether or not (a) the operation position of the shift lever, the shift switch, or the like is in the “parking range” based on the detection signal Ssp of the shift position sensor 72 obtained from the drive ECU 61 via the communication line L, and (b) the electric parking brake device 12 is working based on the detection signal Spb of the parking brake sensor 77. That is, the brake ECU 64 determines whether or not the stopped state of the vehicle 1 can be maintained. Specifically, in a state in which the operation position of the shift lever, the shift switch, or the like of the vehicle 1 is in the “parking range” and the electric parking brake device 12 is working, the stop state of the vehicle 1 can be maintained even in a case where the particular mode is selected. Therefore, the brake ECU 64 determines “Yes” and executes a process of step S14. On the other hand, in a state in which the operation position of the shift lever, the shift switch, or the like is not in the “parking range”, or in a state in which the electric parking brake device 12 is not working, the brake ECU 64 makes a “No” determination, and executes a step process of step S15, which will be described below.

In step S14, the brake ECU 64 determines whether or not a slope gradient K on which the vehicle 1 is stopped is smaller than a predetermined gradient a based on the detection signal Ssl of the gyro sensor 78 or the signal Sns from the navigation device 9. That is, the brake ECU 64 determines whether or not the vehicle 1 stopped on the road having the slope gradient K can maintain the stopped state. Specifically, when the slope gradient K is smaller than the predetermined gradient a, the brake ECU 64 makes a “Yes” determination, and executes a step process of step S16. On the other hand, if the slope gradient K is equal to or greater than the predetermined gradient a, the brake ECU 64 determines “No” because a possibility that the vehicle 1 starts moving is relatively high. Then, the brake ECU 64 executes a process of step S17, which will be described below.

In step S16, the brake ECU 64 makes a transition from the normal mode to the particular mode in accordance with the determinations in step S12 and step S14. Then, in accordance with the transition to the particular mode, the brake ECU 64 controls the master cut valve 116 in the hydraulic brake device 11 to the closed state (or maintains the closed state), thereby releasing a cooperation between the brake pedal 111 and the brake actuator 113 and stopping the operation of the brake actuator 113. As a result of this, in the particular mode, the front-wheel-side brakes 114 and the rear-wheel-side brakes 115 do not operate, that is, the brake pad BP of each of the front-wheel-side brakes 114 and the rear-wheel-side brakes 115 is not pressed against the brake disc BD in response to the depressing operation of the brake pedal 111.

Further, the brake ECU 64 controls the simulator cut valve 117 in the hydraulic brake device 11 to the open state (or maintains the open state) so that the brake pedal 111 is linked only to the stroke simulator 118. Here, in the state after the transition to the particular mode, the brake ECU 64 outputs brake operation information S indicating the depression operation amount of the brake pedal 111 by the occupant to the particular mode ECU 65. Then, the brake ECU 64 temporarily ends the execution of the particular mode transition program in step S18, and starts the execution of the particular mode transition program again in step S10 after a lapse of a predetermined short time.

Moreover, in accordance with the “No” determination in step S11, the brake ECU 64 executes a step process of step S13. In step S13, the brake ECU 64 controls the traveling state of the vehicle 1 in accordance with the operation of the brake pedal 111 by the driver. That is, in the normal mode, the brake ECU 64 causes the brake pedal 111 to cooperate with the brake actuator 113 and operates the brake actuator 113 to generate the braking force on the wheel 3 by pressing the brake pad BP against the brake disc BD. And, after the brake ECU 64 operates the hydraulic brake device 11 in the normal mode in step S13, the brake ECU 64 temporarily ends the execution of the particular mode transition program in step S18.

In accordance with the “No” determination in step S12, the brake ECU 64 executes the step process of step S15. In step S15, the brake ECU 64 notifies the occupants to shift the operation position of the shift lever, the shift switch, or the like to the “parking range” and start working the electric parking brake device 12. Then, the brake ECU 64 temporarily ends the execution of the particular mode transition program in step S18.

Further, according to the “No” determination in step S14, the brake ECU 64 executes a step process of step S17. In step S17, the brake ECU 64 notifies that the state transition to the particular mode cannot be performed because the vehicle 1 is stopped on the road having the slope gradient K greater than the predetermined gradient a. Then, the brake ECU 64 temporarily ends the execution of the particular mode transition program in step S18.

Here, in the state after the transition to the particular mode, the drive ECU 61 invalidates the operation input of the accelerator pedal to the drive system 5 by the occupant, and outputs accelerator operation information indicating the operation amount of the accelerator pedal to the particular mode ECU 65. In addition, in the state in which the mode has transitioned to the particular mode, the operation ECU 62 and the steering ECU 63 cooperate with each other to invalidate the operation input of the steering to the steering system 8 by the occupant in the steering system 8 and output steering operation information indicating the operation amount of the steering to the particular mode ECU 65. As a result of this, in the game mode and the remote operation mode, the occupant can use the accelerator pedal, the steering wheel, and the brake pedal 111 of the vehicle 1 as input devices.

And, the particular mode ECU 65 can move the virtual moving object displayed on the VR glasses worn by the occupant by using the accelerator operation information and the steering operation information in addition to the brake operation information S described above. Further, the particular mode ECU 65 can transmit, to said another vehicle, for example, the brake operation information S, the accelerator operation information, and the steering operation information each corresponding to the operation generated by the occupants who sees the surrounding situation of said another vehicle displayed on the VR glasses. As a result of this, for example, it is possible to cause said another vehicle, which is located in a remote place where people cannot easily enter due to an occurrence of a disaster or the like, to travel by a remote operation.

As can be understood from the above description, the vehicle brake apparatus 10 is applied to the vehicle including the accelerator pedal, the steering wheel, and the brake pedal 111 each as the operation member, the front motor 51 and the rear motor 52, the reaction force applying actuator 83, the steering actuator 85, and the brake actuator 113 each as the electric actuator capable of controlling the traveling state of the vehicle 1 by disengaging the mechanical connection with the accelerator pedal, the steering wheel, and the brake pedal 111, and the drive ECU 61, the operation ECU 62, the steering ECU 63, and the brake ECU 64 each as the controller 6 that controls the operation of each of the electric actuators according to the operation on the accelerator pedal, the steering wheel, and the brake pedal 111.

And, the vehicle brake apparatus 10 includes the brake pedal 111 that is the brake operation member and the brake actuator 113 included in the electric actuator. The brake ECU 64, that is the controller 6, can control the operation of the brake actuator 113 so as to generate the braking force on the wheel 3 of the vehicle 1 in accordance with the operation on the brake pedal 111. In the brake device for the vehicle, the brake ECU 64 obtains the request flag F as the mode selection information indicating whether or not the traveling state is controlled by the operations of the front motor 51 and the rear motor 52 corresponding to the operations of the accelerator pedal, the steering wheel, and the brake pedal 111, the reaction force applying actuator 83 and the steering actuator 85, and the brake actuator 113. The brake ECU 64 restricts at least the operation of the brake actuator 113 corresponding to the brake pedal 111 when the particular mode in which the traveling state is not controlled is selected based on the obtained request flag F.

According to this, when the particular mode in which the traveling state is not controlled is selected, the vehicle brake apparatus 10 can limit at least the operation of the brake actuator 113 in accordance with the brake pedal 111. As a result of this, in the vehicle brake apparatus 10, it is possible to suppress the operation frequency of the brake actuator 113. As a result, it is possible to suppress applying an unnecessary load to the brake caliper BC, the brake pad BP, and the brake disc BD which are members operated to generate the braking force, and it is possible to suppress energy wastefully consumed along with the operation of the brake actuator 113.

### 4. Modifications

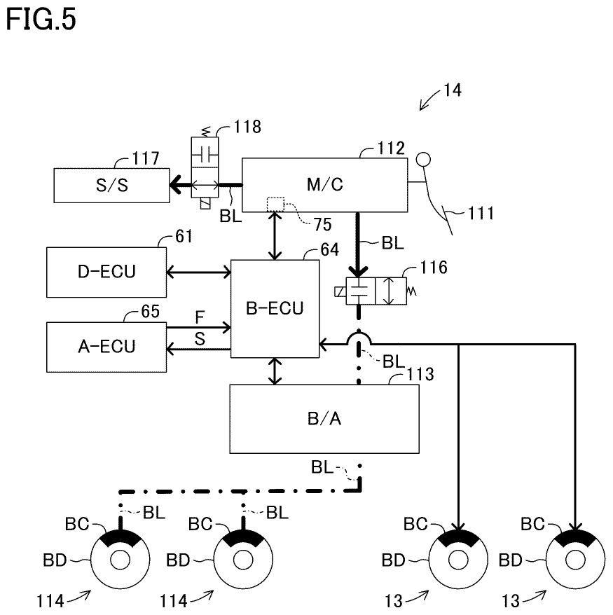

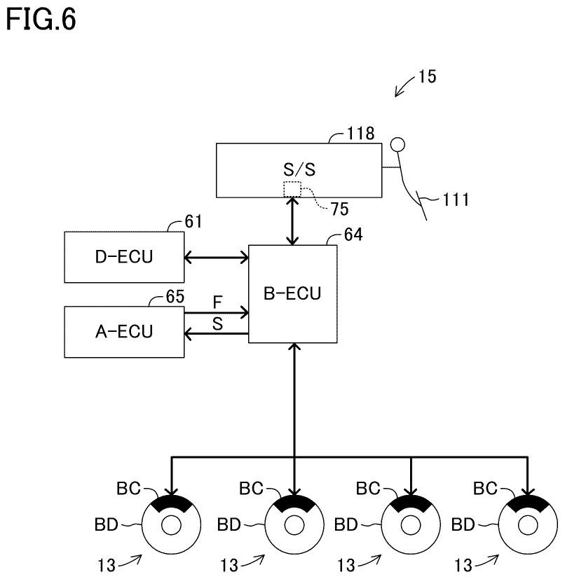

In the above-described embodiment, there has been exemplified the hydraulic brake device 11 in which the front-wheel-side brakes 114 and the rear-wheel-side brakes 115 are provided on the wheels 3. Instead of this, as shown in FIG. 5, it is possible to adopt a brake apparatus 14 in which an electric brake device 13 is provided in each of the rear right wheel 33 and the rear left wheel 34. Further, as shown in FIG. 6, it is also possible to provide a brake device 15 in which the electric brake devices 13 are provided for all the wheels 3. It is noted that, in the case of the brake device 15, the master cylinder 112, the brake actuator 113, the master cut valve 116, and the simulator cut valve 117 are omitted, and as shown in FIG. 6, the brake pedal 111 is directly connected to the stroke simulator 118.

While the front-wheel-side brakes 114 and the rear-wheel-side brakes 115 of the above-described hydraulic brake device 11 are operated by the pressure of the hydraulic oil, the electric brake device 13 is operated by the force of an electric motor that is a drive source. Therefore, as illustrated in FIG. 3C, in the electric brake device 13, a brake actuator 131 having an electric motor (not illustrated) and included in the electric actuator is fixed to the brake caliper BC. And, in the electric brake device 13, the piston 132 can be advanced and retracted by driving force of the brake actuator 131.

Here, an operation of the brake actuator 131 is electrically controlled by the brake ECU 64. As a result of this, the brake ECU 64 can cause the piston 132 to press the brake pad BP accommodated in the brake caliper BC by operating the brake actuator 131. Therefore, the brake ECU 64 can generate the braking force by the frictional force on the wheel 3 by pressing the brake pad BP against the brake disc BD.

And, also in the modifications, the brake ECU 64 executes the particular mode transition program shown in FIG. 4 in the same manner as in the above-described embodiment. In the modifications, the brake ECU 64 stops the electrical control of the brake actuator 131 in step S16. As a result of this, the brake actuator 131 does not operate, that is, the brake pad BP is not pressed against the brake disc BD in response to the depressing operation of the brake pedal 111. Therefore, also in the modifications, the same effects as those of the above-described embodiment can be achieved.

### 5. Other Modifications

In the embodiment and the modifications described above, there has been exemplified the vehicle brake apparatus 10 in a case where the front wheel side brakes 114, the rear wheel side brakes 115, and the electric brake device 13 are disc brakes including the brake disc BD. However, the vehicle brake apparatus 10 may have at least one drum brake including a brake drum and a brake shoe.

Further, in the embodiment and the modifications described above, there has been exemplified a case where the vehicle 1 is an electric vehicle (EV) using only electric motors as driving force sources. However, the vehicle 1 may be, for example, a hybrid electric vehicle (HEV), a plug-in hybrid electric vehicle (PHEV), or the like) each having an internal combustion engine and an electric motor as driving force sources, or a vehicle having only an internal combustion engine as a driving force source.

Moreover, in the embodiment and the modifications described above, the brake ECU 64 determines whether or not the wheels 3 (the rear right wheels 33 and the rear left wheels 34) of the vehicle 1 are mechanically braked in step S12 and determines whether or not the slope gradient K is smaller than the predetermined gradient a in step S14 when executing the particular mode transition program. However, if necessary, the brake ECU 64 may execute one of the step process of step S12 and the step process of step S14. Even in this case, since the brake ECU 64 can determine whether or not the stopped state of the vehicle 1 can be maintained in the state in which the particular mode is selected, the same effects as those of the embodiment and the modifications described above can be achieved.

Further, in the embodiment and the modifications described above, the brake ECU 64 included in the controller 6 executes the particular mode transition program. However, the execution of the particular mode transition program is not limited to being executed by the brake ECU 64, and may be executed by any one of the drive ECU 61, the operation ECU 62, and the steering ECU 63 included in the controller 6.

What is claimed is:

1. A vehicle brake apparatus applicable to a vehicle,
the vehicle comprising:
an operation member;
an electric actuator configured to control a traveling state of the vehicle in which a coupling between the electric actuator and the operation member is mechanically disengaged; and
a controller configured to control an operation of the electric actuator in accordance with an operation to the operation member,
the vehicle brake apparatus comprising:
a brake operation member included in the operation member; and
a brake actuator included in the electric actuator,
the controller being configured to control an operation of the brake actuator such that braking force is applied to at least one wheel of the vehicle in accordance with an operation to the brake operation member,
wherein the controller is configured to:
obtain mode-selection information indicating whether or not a control of the traveling state is to be performed by the operation of the electric actuator in accordance with the operation to the operation member, and
in response to selecting a particular mode, based on the obtained mode-selection information, in which the control of the traveling state is not performed, limit at least the operation of the brake actuator in accordance with the operation of the brake operation member.

2. The vehicle brake apparatus according to claim 1,
wherein the controller is configured to:
determine whether or not a stopped state of the vehicle is maintained in response to selecting the particular mode; and
when it is determined that the stopped state in maintained, limit the operation of the brake actuator by shifting from a normal mode, to the particular mode, in which the control of the traveling state is performed by the operation of the electric actuator in accordance with the operation to the operation member.

3. The vehicle brake apparatus according to claim 2,
wherein the controller is configured to determine whether or not the stopped state of the vehicle is maintained based on determinations of (a) whether or not the at least one wheel of the vehicle is mechanically braked, (b) whether or not an slope gradient of a road surface on which the vehicle is stopped is smaller than a predetermined gradient, or (c) whether or not the at least one wheel of the vehicle is mechanically braked and whether or not the slope gradient of the road surface on which the vehicle is stopped is smaller than the predetermined gradient.

4. The vehicle brake apparatus according to claim 1,
in a state in which the operation of the brake actuator is limited by the controller, the coupling between the operation member and the brake actuator is disengaged and the operation member is coupled to an operation reaction force device in which a reaction force is generated in accordance with the operation to the operation member.

5. The vehicle brake apparatus according to claim 1,
wherein the particular mode is a game mode in which a movement of a virtual moving object is controlled by an operation to an input device installed on the vehicle including the operation member or a remote operation mode in which another vehicle located at a position away from the vehicle is driven and caused to travel by using equipment installed on the vehicle including the operation member.
